(19) United States
(12) Patent Application Publication
(10) Pub. No.: US 2021/0394683 A1
(43) Pub. Date: Dec. 23, 2021

(54) Automobile Dryer System

(71) Applicant: Don Taylor, Elizabeth, CO (US)

(72) Inventor: Don Taylor, Elizabeth, CO (US)

(21) Appl. No.: 16/909,509

(22) Filed: Jun. 23, 2020

(51) Int. Cl. B60R 7/10

(52) U.S. Cl. CPC B60R 7/10; B60R 2011/0056

(57) ABSTRACT

An apparatus for holding objects in an automobile is disclosed. The device includes: a cord for adjusting the position of objects; a stanchion for holding the cord; and at least one clip to hold the object. Wherein the stanchion is configured to secure the cord at various positions. Additionally, there is a device for securing a cord. The device includes: a disc with an arc rising perpendicular to the disc. Wherein the arc is divided into multiple towers by multiple canyons. Wherein the width of the canyons is smaller than the diameter of the cord. Wherein the cord is held in place by being pressed into at least one of the canyons.

### TECHNICAL FIELD

This invention relates to devices for securing objects in an automobile and further for drying objects utilizing the heating system of an automobile.

### BACKGROUND

Automobiles are an integral part of life today. Automobiles are a means of transporting people and their possessions. Most automobiles are equipped with a multitude of locations for storing possessions. Generally, these locations are not on the dashboard, and any object placed on the dashboard will slide as the car turns or stops. The dashboard is often made from materials that give little purchase to objects placed there.

### SUMMARY

In a first aspect, the disclosure provides an apparatus for holding objects in an automobile. The device includes: a cord for adjusting the position of objects; a stanchion for holding the cord; and at least one clip to hold the object. Wherein the stanchion is configured to secure the cord at various positions.

In a second aspect the disclosure provides a device for securing a cord. The device includes: a disc with an arc rising perpendicular to the disc. Wherein the arc is divided into multiple towers by multiple canyons. Wherein the width of the canyons is smaller than the diameter of the cord. Wherein the cord is held in place by being pressed into at least one of the canyons.

Further aspects and embodiments are provided in the foregoing drawings, detailed description, and claims.

### BRIEF DESCRIPTION OF THE DRAWINGS

The drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a view of one embodiment of the drying system attached to an automobile.

FIG. 2 is a view of an embodiment of the drying system with a mitten attached to the drying system.

FIG. 3 is a top view of the drying system.

FIG. 4 is a perspective view of the drying system.

FIG. 5 is a view of the stanchion and the cord.

FIG. 6 is a view of the bottom of the stanchion.

FIG. 7 is a view of one method of attachment for the stanchion.

### DETAILED DESCRIPTION

The following description recites various aspects and embodiments of the inventions disclosed herein. No particular invention is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

Definitions

The following terms and phrases have the meanings indicated below, unless otherwise provided herein. This disclosure may employ other terms and phrases not expressly defined herein. Such other terms and phrases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly indicates otherwise. For example, reference to “a substituent” encompasses a single substituent as well as two or more substituents, and the like.

As used herein, “for example,” “for instance.” “such as,” or “including” are meant to introduce examples that further clarify more general subject matter. Unless otherwise expressly expressly indicated, such examples are provided only to aid in understanding embodiments illustrated in the present disclosure and are not meant to be limiting in any fashion. Nor do these phrases indicate any kind of preference for the disclosed embodiment.

As used herein “braided cord” is meant to refer to cords constructed with fibers braided together. In this process many fibers pass above, below, and around one another. Often the braid is constructed around filler fibers. There are multiple methods for braiding. Solid braid ropes are a complex braid often around a filler core. Diamond braids rotate fibers over and under one another in opposing directions and often is braided around a filler core. Double braided cords are essentially a rope within a rope. One braid is formed around another braid. Braided cords are constructed from a variety of materials including nylon, polyester, Kevlar, dyneema, spectra, and polypropylene.

As used herein “twisted cord” is meant to refer to cords that twist at least three strands of fibers in alternate directions and appear to spiral around one another. Twisted cords are constructed from a variety of materials including cotton, hemp, polyester, nylon, polypropylene, and Kevlar.

As used herein “monofilament cord” is meant to refer to cords made from a single fiber of plastic. Monofilament cords are made my melting and mixing polymers and then extruding the mixture through holes, forming strands of cord. The extrusion process controls the thickness and strength of the cord. Monofilament cords are constructed from a variety of materials including nylon, Spectra®, Dyneema®, and polyvinylidene fluoride.

As used herein “plastic” is meant to refer to materials consisting of synthetic or semi-synthetic organic compounds that are malleable and can be molded into solid objects. Plastics are typically organic polymers of high molecular mass and often include other substances. Plastics are generally synthetic, most commonly derived from petrochemicals. Plastics are impervious to water. Plastics include: polyamids (nylons), polycarbonate, polyethylene, polypropylene, polyvinyl chloride (PVC), Acrylonitrile butadiene styrene (ABS), polymethyl methacrylate (PMMA or acrylic), and other materials.

Automobiles are a very useful and important part of many people's lives. Automobiles are used for transporting people to and from work, for shuttling children to various activities, for visiting distant locations, for road trips, as base camps on trips and in some instances as homes. Automobiles are often a source of comfort and security.

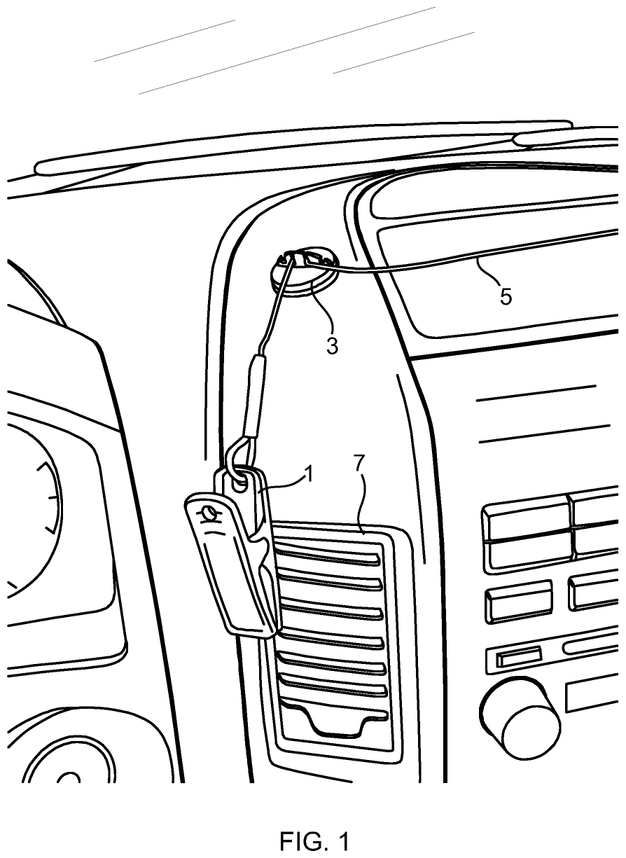

Now referring to FIG. 1 which shows the automobile drying system. The automobile drying system includes an attachment clip 1 for holding an object in place over a car vent 7. The clip attaches to a cord 5. To keep the attachment clip 1 in the proper position, the cord 5 runs through and is held in place by a stanchion 3. The stanchion 3 is placed in a location that enables the object held by the attachment clip 1 to hang directly in front of the car vent 7. In one embodiment the stanchion 3 is attached to the automobile by a self-adhesive on the bottom of the stanchion. The self-adhesive attaches the stanchion 3 in a semi-permanent way. When used in this embodiment with the self-adhesive on the stanchion the stanchion cannot be removed and replaced without replacing the adhesive. In the preferred embodiment the stanchion attaches to the automobile with hook and loop material. In this embodiment with hook and loop material one side of the material is attached to the automobile and one side is attached to the stanchion. The side attached to the automobile has a side with adhesive material so that it can be positioned in the optimal place to allow the object held in the attachment clip to be placed in front of the vent. This preferred embodiment also enables the stanchion to be removed when not in use.

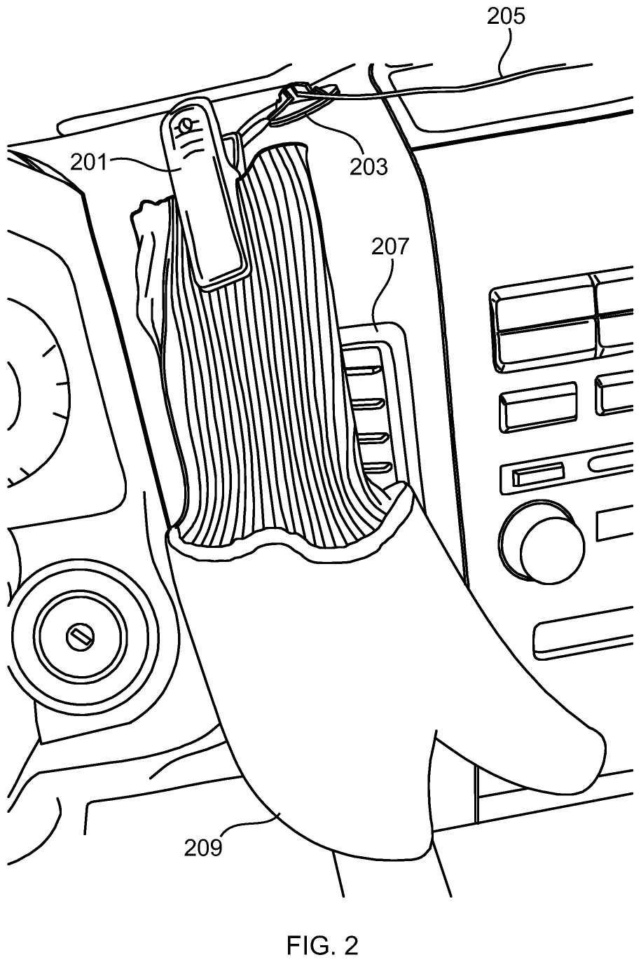

Referring now to FIG. 2 which shows the automobile drying system with a mitten 209 held in the attachment clip for drying. A mitten 209 is held in the attachment clip 201. The cord 205 has been adjusted so that the attachment clip 201 will hold the mitten 209 in front of the vent 207. The length of the cord 205 is adjusted by securing it in the stanchion 203. The stanchion 203 is secured to the dashboard so that an object held in the attachment clip 201 hangs in front of the vent 207. In many embodiments one stanchion is included in the system. In other embodiments, multiple stanchions are included in the system. The inclusion of multiple stanchions allows multiple objects to be located

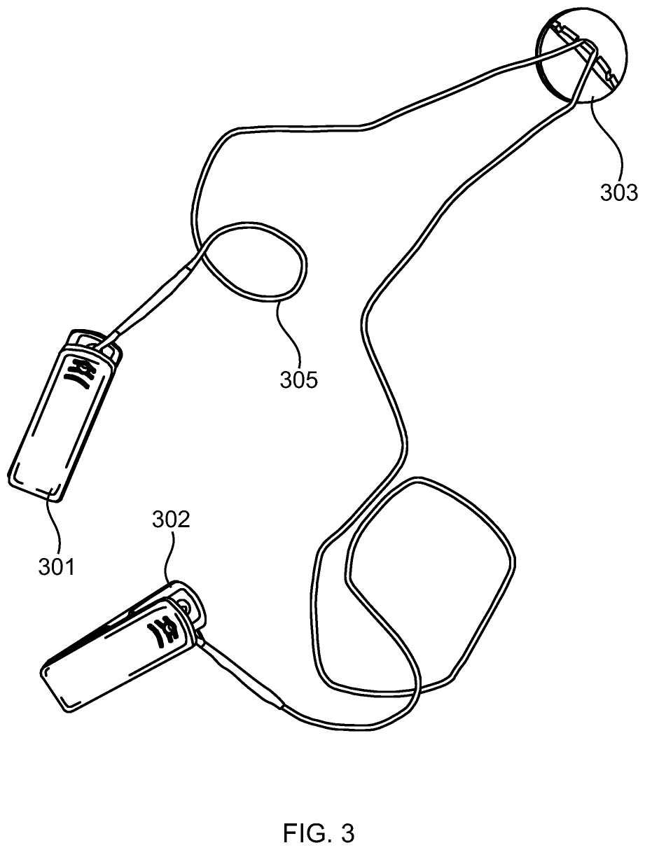

Now referring to FIG. 3 which shows an overhead view of one embodiment of the automobile dryer system. In this embodiment there are two attachment clips 301 and 302. These attachment clip are attached on opposite ends of the cord 305. In some embodiments the cord is a braided cord. There are several types of braided cords. Solid braided cords are a complex braid that often has a filler core. Diamond braids rotate fibers over and under one another in opposing directions and often has a filler core. Double braided cords are essentially a rope within a rope, one braid is formed over another braid. In other embodiments the cord is a twisted cord. Twisted cords are typically made by twisting at least three strands in alternate directions.

In embodiments with two clips the automobile dryer system is able to dry multiple objects. The cord is held in place by the stanchion 303. The cord fits through canyons in the stanchion 303. The canyons are configured to hold the cord securely and allow changing the location of the object attached to either of the clips 301 or 302. The stanchion 303 holds the cord 305 securely and the clips 301 and 302 are able to be independently adjusted so that objects held in the clips are located wherever the user desires.0

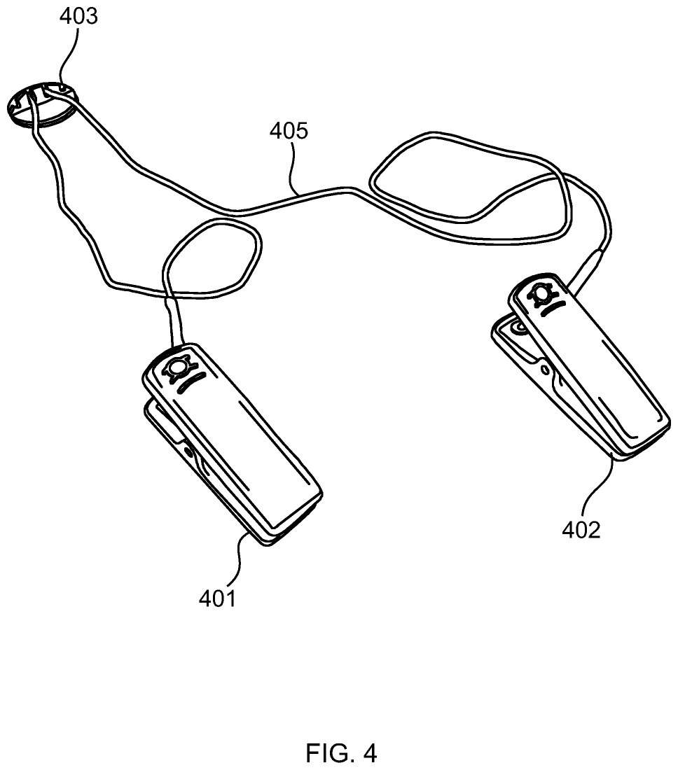

FIG. 4 is an alternative view of the car dryer system. This embodiment includes clips 401 and 402 on each end of the cord. The cord runs through and is held in place by the stanchion 403.

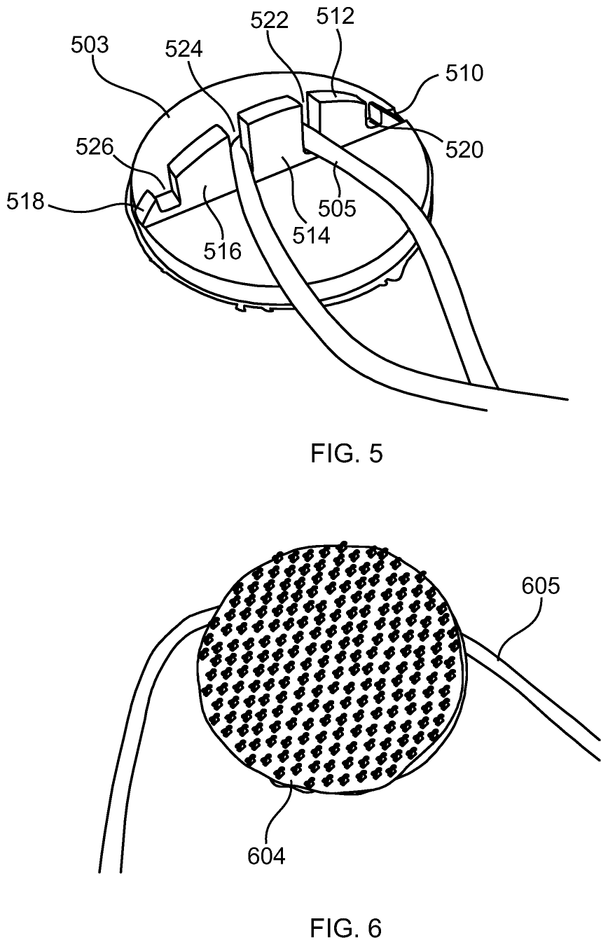

FIG. 5 is a close-up view of the stanchion 503. The stanchion 503 is a disc with an arc positioned perpendicular to the disc spanning the diameter of the disc. The arc is divided into five towers 510, 512, 514, 516, and 518 separated by four canyons 520, 522, 524, and 526. The canyons are slightly smaller than the diameter of the cord 505. The cord 505 is compressible, which allows the cord to seat securely within the canyons. By being smaller than the diameter of the cord the canyons grip the cord and prevent it sliding through the canyon. A more secure hold comes by securing the cord 505 through multiple canyons. In the pictured embodiment of FIG. 4 the cord passes through one canyon 522 around one tower 514 and through canyon 524. This is a simple alignment of the cord and will secure the cord in place to hold an object in the preferred location. The stanchion includes more towers and canyons so as to enable changing the location of the object hanging by the vent. For example, to move the location of the object hanging from the clip on the end of cord 505 running through canyon 524, the cord 505 is run through canyon 526. To shorten the cord slightly and raise the object attached to the end of the cord slightly, the cord can be tightly wrapped around the front side of the tower 516 through the canyon 526 and tightly around the back side of tower 516. To shorten the cord further the cord can be run through canyon 526 without being tightly wrapped around the tower 516. In some respects it may seem counter intuitive to run the cord around the tower 516 without wrapping it tightly around tower 516. However, because the canyons hold the cord snuggly the tightness of the cord around the towers is not the factor that secures the cord and holds the object in place.

In the preferred embodiment the stanchion is made from plastic. Plastic is lightweight and can easily be formed into whatever shape desired. In some alternate embodiments the stanchion is made from a metal. Metal used for making the stanchion include aluminum, aluminum alloys, titanium, steal, stainless steel, and magnesium. In some of the embodiments utilizing a metal, the metal is coated. Such coatings include powder coats, galvanization, anodization, and plasticized coatings. In yet other embodiments the stanchion is made of wood.

FIG. 6 is a view of the bottom of one embodiment of the stanchion. In this embodiment the hook portion 604 of hook and loop fasteners is attached to the bottom of the stanchion. This hook portion 604 attaches to a loop portion. In this embodiment the loop portion has its own adhesive backing. The loop portion is semi-permanently attached to the automobile, it can be removed but the adhesive will have to be reattached to the back of the loop material. Additionally, there are dashboard protectors that have carpet-like or loop-like material, the hook portion can be attached at any point on this dashboard protector.

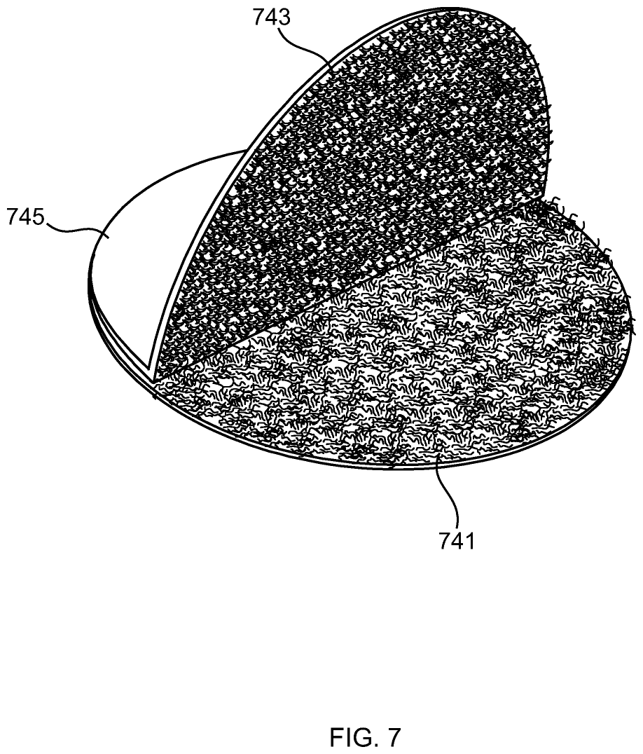

FIG. 7 is a view of the portions of hook and loop material. In this figure the hook portion 743 is being pulled away from the loop portion 741. Both portions have been configured to fit beneath the stanchion. In some embodiments both portions of the hook and loop material have adhesive on the back side of the material. For example, the hook portion 743 has adhesive affixed to the back side of the material. In many embodiments this adhesive is protected by a backing 745 that is removed when the hook portion 743 is to be attached to the stanchion. In many embodiments, the loop portion 741 also has adhesive affixed to the back of the material. The adhesive on both portions allows the stanchion to be attached to an automobile, which then allows objects, such as the mitten described in FIG. 2, to be placed adjacent to the automobile vent and dried using the automobile heating system. When there is no need to dry objects, the stanchion can be removed so the automobile dashboard is uncluttered. Alternatively, the system can be used to hold and secure objects.

In one alternative embodiment, the stanchion is attached to the back of the seat. In this embodiment objects attached to the attachment clips will hang near the rear vents. In some of these embodiments, the hook portion of the hook and loop material attaches to the back of the seat. In some alternative embodiments the stanchion attaches to the seat using adhesive secured to the bottom of the stanchion.

In another alternative embodiment, the stanchion is attached to the ceiling of the automobile. Typically, in this embodiment the stanchion has the hook portion of hook and loop material attached to the bottom of the stanchion. The hook portion on the bottom of the stanchion attaches to the material of the ceiling. The stanchion will be placed near the heating vents. In a further alternative embodiment, it is not necessary to position the objects held in the attachment clips near the automobile vents. In some instances it is even preferable to position the objects away from the vents because some objects are damaged by heat. Therefore, positioning these objects away from vents will protect the objects or the materials from damage.

All patents and published patent applications referred to herein are incorporated herein by reference. However, any reference to prior publication is not, and should not be taken as an acknowledgement, admission, or suggestion that the prior publication, or any information derived from it is part of the general common knowledge in the field of endeavor to which this specification relates. The invention has been described with reference to various specific and preferred embodiments and techniques. Nevertheless, it is understood that many variations and modifications may be made while remaining within the spirit and scope of the invention.

What is claimed is:

1. An apparatus for holding objects in an automobile comprising;
a cord for adjusting the position of objects;
a stanchion for holding the cord;
at least one clip to hold the object;
wherein the stanchion is configured to secure the cord at various positions.

2. The invention of claim 1, wherein the stanchion comprises:
a disc with an arc rising perpendicular to the disc;
wherein the arc is divided into multiple towers by multiple canyons;
wherein the width of the canyons is smaller than the diameter of the cord;
wherein the cord is held in place by being pressed into at least one of the canyons.

3. The invention of claim 1, wherein the stanchion includes an adhesive for attaching to an automobile.

4. The invention of claim 1, wherein the stanchion is configured to be removed from and reattached to the automobile.

5. The invention of claim 3, wherein a bottom surface of the stanchion comprises one side of hook and loop material, and the other side of the hook and loop material is attached to the automobile.

6. The invention of claim 4, wherein the hook portion of the hook and loop material is attached to the bottom surface of the stanchion.

7. The invention of claim 3, wherein the bottom surface of the stanchion comprises a suction cup.

8. The invention of claim 1, wherein the object is dried by being positioned adjacent to a vent of an automobile.

9. The invention of claim 4, wherein the stanchion is attached to the dashboard of the automobile.

10. The invention of claim 4, wherein the stanchion is attached to the ceiling of the automobile.

11. A device for securing a cord comprising;
a disc with an arc rising perpendicular to the disc;
wherein the arc is divided into multiple towers by multiple canyons;
wherein the width of the canyons is smaller than the diameter of the cord;
wherein the cord is held in place by being pressed into at least one of the canyons.

12. The invention of claim 11, wherein the arc is divided into five towers by four canyons.

13. The invention of claim 11, wherein the device is adapted to be secured to a surface.

14. The invention of claim 13, wherein the device is adapted to be removably secured to a surface.

15. The invention of claim 14, wherein a bottom surface of the disc comprises an adhesive for securing to a surface.

16. The invention of claim 14, wherein a bottom surface of the disc comprises a suction cup.

17. The invention of claim 14, wherein the stanchion is attached to the dashboard of the automobile.

18. The invention of claim 14, wherein the stanchion is attached to the ceiling of the automobile.

19. The invention of claim 14, wherein the stanchion is attached to the back of a seat.
